(19) United States
(12) Patent Application Publication
(10) Pub. No.: US 2015/0294759 A1
(43) Pub. Date: Oct. 15, 2015

(54) Foldable Electric Cable and Manufacturing Method Thereof

(71) Applicant: David Lowery Mears, Gravette, AR (US)

(72) Inventor: David Lowery Mears, Gravette, AR (US)

(21) Appl. No.: 14/251,559

(22) Filed: Apr. 11, 2014

(51) Int. Cl. H01B 7/04; H01B 13/00; H01B 13/24; H01B 7/02; H01B 3/30

(52) U.S. Cl. CPC H01B 7/04; H01B 7/0275; H01B 3/30; H01B 13/24; H01B 13/0003

(57) ABSTRACT

A foldable electric cable having a core with conductors and a sheath; where in the sheath consists of rigid and soft sections so that the electric cable is capable of being folded. A method for the manufacturing of the foldable electric cable through the use of an alternate polymer extrusion system; whereby the rigid and soft polymer materials are deposited around the core of conductors.

### CROSS-REFERENCE TO RELATED APPLICATIONS

The present application is claiming benefit of a prior filed provisional application Ser. No. 61/811,244 filed on Apr. 12, 2013.

### BACKGROUND

The statements in this section merely provide background information related to the present disclosure and may not constitute prior art.

### FIELD OF THE INVENTION

The present disclosure relates to an electric cable that is capable of being folded.

### DESCRIPTION OF THE RELATED ART

Different lengths and types of cables are available on the market; however, one key problem that exists with current cables is they are disposed to being tangled. Traditionally, the outer layer, sheath, of the cable is made of one polymer that provides insulation and allows the cable to remain flexible. Even though the cable is flexible, the user is unable to fold the cable and thus cables frequently tangle. Additionally, cables generally require extra storage space due to the inability of the user to fold the electric cable.

Therefore, it is desirable to have an electric cable that remains untangled when stored and which requires minimal storage space without forfeiting length.

### SUMMARY

The present invention provides an electric cable that is capable of being folded and thus tangle free due to the use of polymer materials with different strengths during the manufacturing process when forming the sheath around the core of conductors.

According to one aspect, a foldable electric cable includes a sheath of two polymer materials, one rigid and one soft. The sheath includes numerous sections of two different lengths, wherein the longer sections are made of rigid polymer material and the shorter sections are made of soft polymer material. The beginning and ending sections of the sheath are also made of the soft polymer material. The softer sections of the sheath enable the user to fold the electric cable and thus allowing the cable to remain untangled.

Further aspects of the present disclosure will be in part apparent and in part pointed out below. It should be understood that various aspects of the disclosure may be implemented individually or in combination with one another. It should also be understood that the detailed description and drawings, while indicating certain exemplary embodiments, are intended for purposes of illustration only and should not be construed as limiting the scope of the disclosure.

### BRIEF DESCRIPTION OF THE DRAWINGS

FIG. 1 A perspective view of the foldable electric cable in folded position;

FIG. 2 A perspective longitudinal sectional view of the foldable electric cable with rigid and soft sections;

FIG. 3 A cross-sectional view of the cable with the core, conductors and sheath; and

FIG. 4 A flow chart of the manufacturing method for foldable electric cable.

### DETAILED DESCRIPTION

The following description is merely exemplary in nature and is not intended to limit the present disclosure or the disclosure's applications or uses.

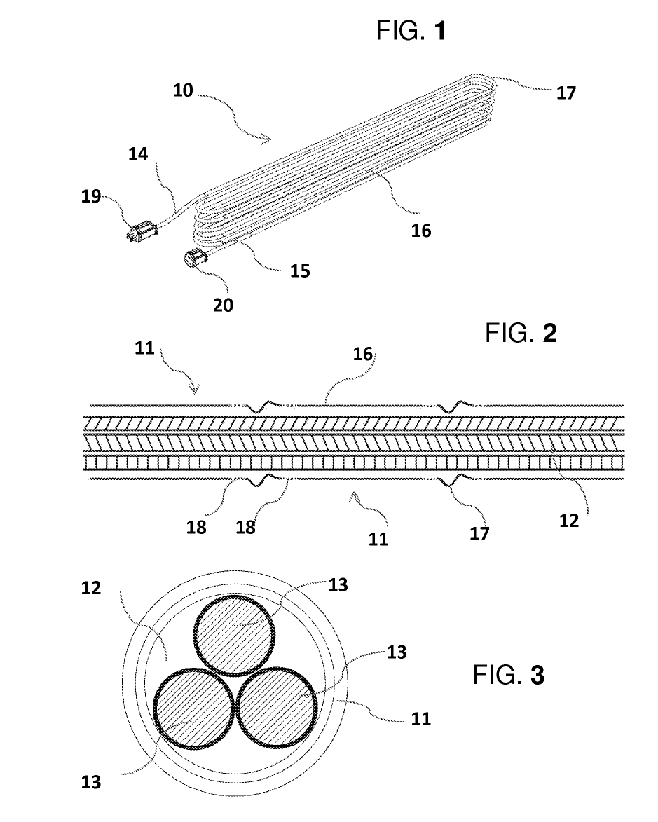

FIGS. 1 through 3 illustrate the invention, a foldable electric cable 10. The foldable electric cable 10 includes a sheath 11, a core 12 with a plurality of conductors 13, a first end 14 and a second end 15. The sheath 11 includes a plurality of rigid sections 16 and a plurality of soft sections 17. The rigid sections 16, arms, and the soft sections 17, elbows, are made of polymers with different Durometer Type A (Shore A) hardness. The number of rigid sections 16 and soft sections 17 depends on the desired overall length of the foldable electric cable 10 as well as the size of the foldable electric cable 10 when folded. The overall length of the foldable electric cable 10 may be of various lengths and the folded size of the cable may differ depending on the length of the rigid sections 16. The sheath 11 at the first end 14 and at the second end 15 of the foldable electric cable 10 are made from the soft polymer material.

As shown in FIG. 4, the method for manufacturing the foldable electric cable begins with a first step S100 of determining the desired overall length of the foldable electric cable 10; the desired folded size of the foldable electric cable 10, the desired length of each rigid 16 and soft 17 section, and the desired length of the first end 14 and second end 15 sections of the foldable electric cable 10. The process of adding the sheath 11 is through the use of an alternate polymer extrusion system which dispenses the selected rigid and soft polymer materials at a pre-programmed amount. After determining the various lengths in the first step S100, a second step S200 is to program the alternate polymer extrusion system for the delivery of the rigid and soft polymer materials based on the desired lengths determined in the first step S100. A third step S300 is to thread the core 12 of conductors 13 into a die tool in preparation for the adding of the rigid and soft polymer materials to form the sheath 11 of rigid 16 and soft 17 sections. A fourth step S400 is to inject the rigid and soft polymer materials in a consistent thickness to form the sheath 11 based on the programming of the second step S200 using the alternate polymer extrusion system. A transition segment 18 exists between each rigid section 16 and soft section 17 which represents the changeover mixture of the two polymer materials, soft and rigid. A final fifth step S500 after the addition of the sheath 11 in the fourth step S400 is to cut the unfinished foldable electric cable 10 and establish the first end 14 and the second end 15, and to perform the finishing operations such as cleaning of any residue of polymer materials from the first end 14 and the second end 15, crimping of bare wires, and adding of a plug 19 and a socket 20.

When describing elements or features and/or embodiments thereof, the articles “a”, “an”, “the”, “each”, and “said” are intended to mean that there are one or more of the elements or features. The terms “comprising”, “including”, and “having” are intended to be inclusive and mean that there may be additional elements or features beyond those specifically described.

Those skilled in the art will recognize that various changes can be made to the exemplary embodiments and implementations described above without departing from the scope of the disclosure. Accordingly, all matter contained in the above description or shown in the accompanying drawings should be interpreted as illustrative and not in limiting sense.

It is further to be understood that the processes or steps described herein are not to be construed as necessarily requiring their performance in the particular order discussed or illustrated. It is also understood that additional or alternative processes or steps may be employed.

What is claimed is:

1. A foldable electric cable comprising
a core comprised of a plurality of conductors; and
a sheath comprising:
a rigid polymer material; and
a soft polymer material.

2. The foldable electric cable of claim 1, wherein the rigid polymer material and the soft polymer material are deposited individually around the core in alternating desired amounts.

3. The foldable electric cable of claim 1, wherein the rigid polymer material and the soft polymer material are deposited around the core using an alternate polymer extrusion system.

4. A method of manufacturing a foldable electric cable comprising:
determining the desired overall length of the foldable electric cable and the length of the foldable electric cable when folded;
programming an alternate polymer extrusion system for the delivery of a rigid polymer material and a soft polymer material;
threading a core of a plurality of conductors into a die mold;
depositing the rigid polymer and soft polymer materials in a consistent thickness around the core of conductors to create a sheath; and
performing finishing operations comprising the cutting of cable, cleaning and adding of a plug or a socket.
